(19) United States
(12) Patent Application Publication
(10) Pub. No.: US 2010/0060180 A1
(43) Pub. Date: Mar. 11, 2010

(54) CIRCUIT ARRANGEMENT FOR IGNITING AND OPERATING A DISCHARGE LAMP

(75) Inventor: Joachim Muehlschlegel, Groebenzell (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,159

(22) PCT Filed: Apr. 24, 2007
(86) PCT No.: PCT/EP07/53983

§ 371 Date: Nov. 3, 2009

(51) Int. Cl. H05B 41/36

(52) U.S. Cl. 315/224

(57) ABSTRACT

A circuit arrangement for igniting and operating a gas discharge lamp having a half-bridge arrangement, which acts as a step-down inverter in quasi-resonant mode, a lamp inductor and a resonance capacitor that form a resonant circuit, and having an ignition transformer whose secondary winding is connected on the one hand to a lamp electrode and is connected on the other hand to the tie point between the lamp inductor and resonance capacitor, wherein the primary winding of the ignition transformer is connected with its first end to the tie point between the lamp inductor and resonance capacitor, and with its second end to the tie point of two series connected diodes, the first diode being connected to the power supply unit, and the second diode being connected to circuit ground.

### TECHNICAL FIELD

The invention relates to circuit arrangements and electronic operating devices for igniting and operating discharge lamps. Electronic operating devices for gas discharge lamps have been gaining ground over the past years, given that by comparison with the conventional ballasts they offer significant advantages such as higher light quality, better light efficiency and automatic shutdown of the gas discharge lamps at the end of their service life. For high-pressure discharge lamps, use has chiefly been made to date of circuits, with a so-called full bridge, that operate the lamp with a type of alternating direct current. This is necessary because most high-pressure gas discharge lamps cannot be operated with relatively high-frequency alternating currents because of instances of resonance in the burner vessel. It is usual to make use for the ignition of a pulsed ignition device for which a further switch is needed to trigger the ignition pulse. Since this type of inverter is very complicated and expensive, there has recently been a move to operate the lamps with the aid of a symmetric half bridge.

### PRIOR ART

In order to ignite the lamp with the aid of such a circuit it is likewise possible to use a pulsed ignition device. A half-bridge circuit with such a pulsed ignition device is disclosed in EP 1 585 372 A1. The circuit of the ignition device is not specified in this document, but it usually consists of at least one switch, an ignition capacitor and an ignition transformer. This additional switch and the corresponding driving thereof occasion costs which are not to be underestimated. However, attempts have been made very recently to use a resonance ignition for igniting the gas discharge lamp. Thus, it is proposed in U.S. Pat. No. 7,170,235 B2 to combine an inverter in a half or full-bridge circuit with a resonance ignition of the gas discharge lamp. In this case, the resonance is produced by a dedicated switch driven at high frequency and which likewise occasions high costs with the associated drive circuit.

### OBJECT

It is therefore an object of the present invention to specify a circuit arrangement having a half bridge which has resonance ignition without the use of a switch driven at high frequency, or entirely without a driven switch.

### SUMMARY OF THE INVENTION

This object is achieved by the features of patent claim 1 and method claim 11. Particularly advantageous designs of the invention are described in the dependent claims.

The inventive circuit arrangement consists of a half bridge whose center point 24 is connected to a lamp inductor L1 that forms a series resonant circuit 17 together with a resonance capacitor 19. Via the primary winding L2 of an ignition transformer 18, this series resonant circuit 17 provides an elevated voltage for the ignition and acceptance by the gas discharge lamp 5. This high frequency resonance voltage is likewise present across the primary winding L2 of the ignition transformer 18 and effects a current through the primary winding L2 that is discharged via two series connected diodes D1 and D2, and is transformed into a high voltage in the secondary winding L3. Alternatively, instead of the second diode D2 it is possible to use a cost effective slow switch that is turned on during on the ignition phase and remains turned off after the ignition of the gas discharge lamp. A high ignition voltage that can reliably ignite the gas discharge lamp 5 is superposed by this measure on the resonance voltage of the series resonant circuit. A switch that is expensive because of being fast and is associated with a complicated high-frequency drive can thereby be economized.

The advantageous dimensioning of 70 W gas discharge lamps can be as follows:

| Switching frequency | 100 kHz-400 kHz |
|---|---|
| in normal operation | |
| L1 | 100 μH-300 μH |
| C1 | 4 nF-20 nF |
| L3 | 300 μH-2000 μH |
| L3/L2 | 0.7-6 |

### BRIEF DESCRIPTION OF THE DRAWING(S)

FIG. 1 shows a circuit diagram of the inventive circuit arrangement in accordance with the first embodiment;

FIG. 2 shows a circuit diagram of the inventive circuit arrangement having a DC blocking capacitor C2 in accordance with the second embodiment;

FIG. 3 shows an illustration of relevant signals in the case of resonant excitation in accordance with the first embodiment;

FIG. 4 shows the action of the DC blocking capacitor C2 of the second embodiment, in nominal operation; and

FIG. 5 shows an illustration of relevant signals in the case of resonant excitation in accordance with the second embodiment.

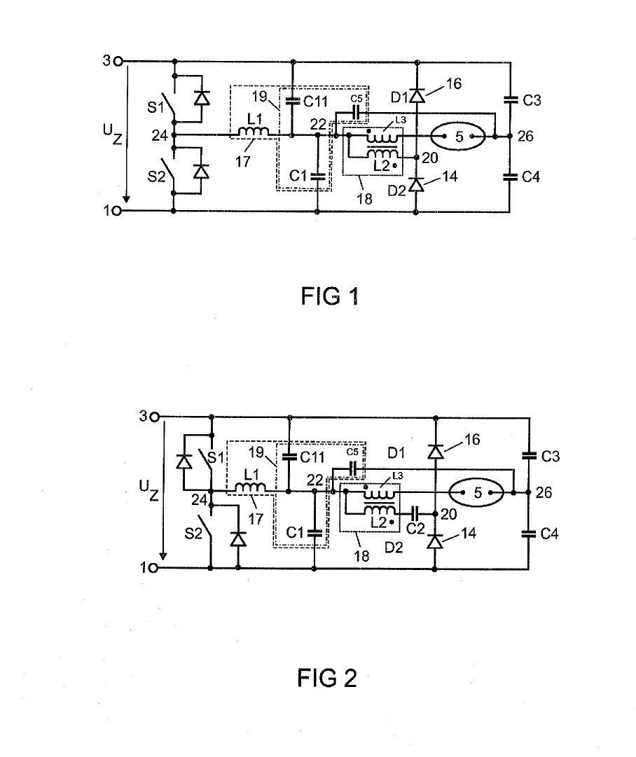

### PREFERRED DESIGN OF THE INVENTION

Two embodiments of the present invention are described below.

### First Embodiment

The circuit arrangement of the first embodiment includes a symmetric half bridge that includes two switches S1 and S2 that are arranged in series and have the associated coupling capacitors C3 and C4. The open ends of the series circuits are connected to the power supply unit 3, on the one hand, and to the circuit ground 1, on the other hand. The intermediate circuit voltage U_{z} is present between the power supply unit 3 and the circuit ground 1. A series circuit composed of a lamp inductor L1, the secondary winding L3 of an ignition transformer 18 and of the gas discharge lamp 5 is connected between the tie points 24 of the two switches and 26 of the two capacitors. A resonance capacitor 19, which is assembled from at least one of the capacitors C1 and/or C11 and/or C5, is connected to the tie point 22 of the lamp inductor L1 and of the secondary winding of the ignition transformer L3. The resonance capacitor 19 forms the series resonant circuit 17 together with the lamp inductor L1. The primary winding is likewise connected with one end to the tie point 22. The other end is connected to the tie point of two series connected diodes that, in turn, are connected with their ends to the power supply unit 3 and to the circuit ground 1. In this case, the cathodes of the diodes respectively point in the direction of the power supply unit 3.

If the half bridge is now operated at a suitable frequency during the ignition phase, the resonant circuit composed of the resonance capacitor 19 with L1 goes into resonance, and a peak voltage is produced that oscillates clearly above the positive and below the negative intermediate circuit voltage. The crest value of the resonance voltage can lie in this case above that of the intermediate circuit voltage by 300 V-1500 V. Since the primary winding is likewise connected at one end to the resonance capacitor 19, during the resonant excitation a high superposed voltage forms on the secondary side of the ignition transformer and is added to the resonance voltage, and this resulting voltage can then ignite the gas discharge lamp connected to the circuit arrangement. The ignition voltage can in this case reach a maximum amplitude of 1000 V-3000 V.

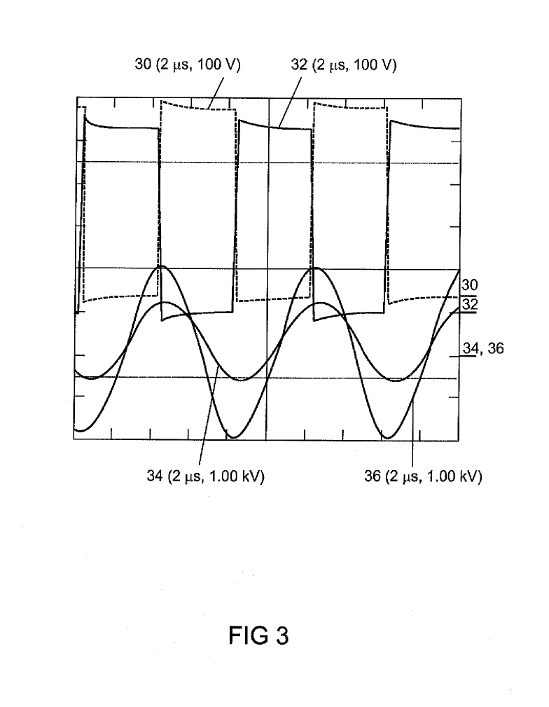

The profile is described below with the aid of FIG. 3. The signal profile 30 illustrates the voltage at the half-bridge center point 24, plotted against circuit ground 1. It is clearly to be seen that it switches back and forth between 0 and 400 V, for example. The signal profile 34 illustrates the voltage across the resonance capacitor 19. The resonant excitation transforms the rectangular curve into a sinusoidal oscillation, and a voltage with an amplitude of approximately 900 V is produced. The signal shape 36 shows the voltage across the lamp, which is composed of the voltage 34 across the resonance capacitor 19 and a portion superposed via the ignition transformer. A voltage with an amplitude of approximately 2000 V is produced. The resonance voltage that is present across the resonance capacitor 19 is applied to the diode center point 20 via the primary winding L2 of the ignition transformer 18. Since the resonance voltage is substantially higher than the intermediate circuit voltage U_{z}, the first diode D1 or the second diode D2 alternately conducts, depending on whether the positive or the negative halfwave of the resonance voltage is present at the time. As a consequence thereof, the voltage at the point 20 is clamped to the voltage at the power supply point 3, or to the ground 1. This results in a curve that is very similar to a square wave. Thus, in the resonance operation a substantial current flows through the primary winding L2 of the ignition transformer 18, from which the ignition transformer 18 generates the abovenamed superposed voltage.

Once the lamp has ignited, the bridge is operated with the aid of a low-frequency square wave voltage in the range of approximately 60 Hz-500 Hz. In order to implement the voltage lowering property of the arrangement, a high-frequency drive is superposed on this low-frequency operation such that the switch that is closed in terms of low frequency is clocked in terms of high frequency. The frequency of the drive is selected such that the bridge switches switch in a quasi-resonant fashion such that only low switching losses occur. Quasi-resonant in this context means that the inductor current is at the boundary between intermittent and continuous operation. The high-frequency square wave voltage of the bridge is smoothed by the resonant circuit 17, which acts as an LC filter in this frequency range, and is fed to the lamp as a square wave voltage with a high-frequency voltage ripple.

The winding ratio of the ignition transformer and the voltage ripple across the resonance capacitor 19 are selected such that no current, or only a very small one, flows through the primary winding L2 of the ignition transformer 18 in the normal operation (lamp which has been run up), since the diodes D1 and D2 are in this case chiefly in the blocking state. Owing to the negligible current through the primary winding L2, virtually the entire no-load inductance of the secondary winding L3 acts as filter inductance. The inductance of the secondary winding L3 for an open primary winding L2 can be regarded as no-load inductance. Short current pulses that are discharged via the diodes D1 and/or D2, can be produced by oscillation reversal operations during the commutation. The current pulses can be formed, on the one hand, from voltage pulses at the point 22 or, on the other hand, from voltage pulses coupled onto the primary winding via the ignition transformer 18. The coupled voltage pulses are produced because of the lamp commutation, and are transferred from the secondary side of the ignition transformer onto the primary side.

The two diodes D1 and D2 therefore act as switching elements that during the ignition phase produce a flow of alternating current through the primary winding L2, and thus a high ignition voltage, and that are open during the normal operation and suppress a flow of current through the primary winding such that the ignition transformer acts as an inductor of high inductance in this phase.

An advantageous dimensioning of 70 W gas discharge lamps can look as follows:

| L1 | 250 | μH |
|---|---|---|
| L2 | 314 | μH |
| L3 | 476 | μH |
| C1 | 10 | nF |
| C11 | 0 | |
| C5 | 0 | |
| C3, C4 | 68 | μF |

### Second Embodiment

The second embodiment is very similar to the first embodiment. Consequently, only the differences in relation to the first embodiment are set forth.

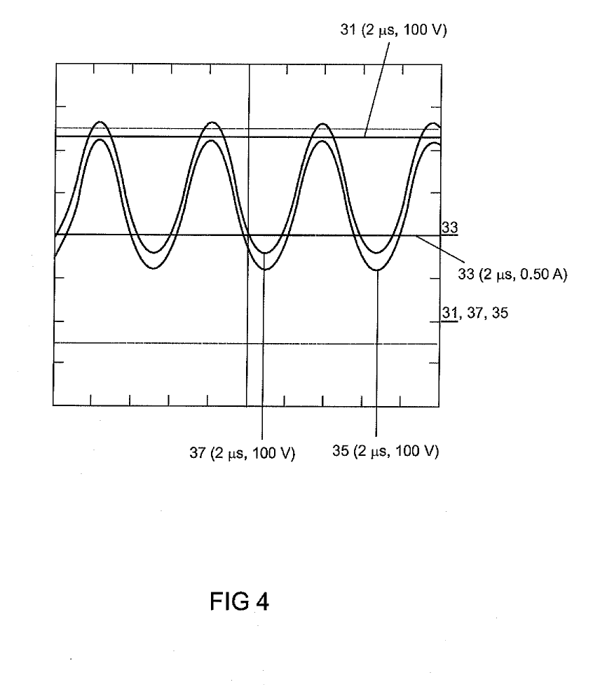

As an alternative to this dimensioning, a DC blocking capacitor C2 that suppresses the flow of current in the primary winding in the normal operation can be connected between the primary winding L2 and diode center point 20. Of course, the DC blocking capacitor C2 can also be arranged at another suitable location on the path from point 22 to point 1 or to point 3. The DC blocking capacitor enables greater dimensioning freedom for the winding ratio and the voltage ripple across C1. This can be appreciated with the aid of FIG. 4. Signal 31 shows the intermediate circuit voltage that is present at point 3. Signal 35 shows the voltage at the center of the diode in relation to the ground point 1. The voltage is within the intermediate circuit voltage, since in the case of higher voltages the diodes would be conducting, and thus the voltage would clamp at the intermediate circuit voltage as it does in the resonance operation. Signal 37 shows the voltage across the primary winding L2 in relation to the ground point 1. Since respectively only direct current can flow via the diodes D1 and D2, C2 suppresses the flow of current in the case when, even in the normal operation, the voltage ripple at the diode-side end of the primary winding L2 lies at times above the intermediate circuit voltage. In this case, after the commutation of the low-frequency lamp current C2 charges up to a voltage that corresponds to the difference between the peak value at the primary winding and the intermediate circuit voltage. Signal 33 represents the current through the primary winding L2. It is easy to see that virtually no current flows through the primary winding L2, even when the voltage ripple across the capacitor 19 is higher than the intermediate circuit voltage. Because no current flows through the primary winding, the ignition transformer can act wholly as a smoothing inductor in the normal operation, and protect the gas discharge lamp 5 against the high voltage ripple across the capacitor 19.

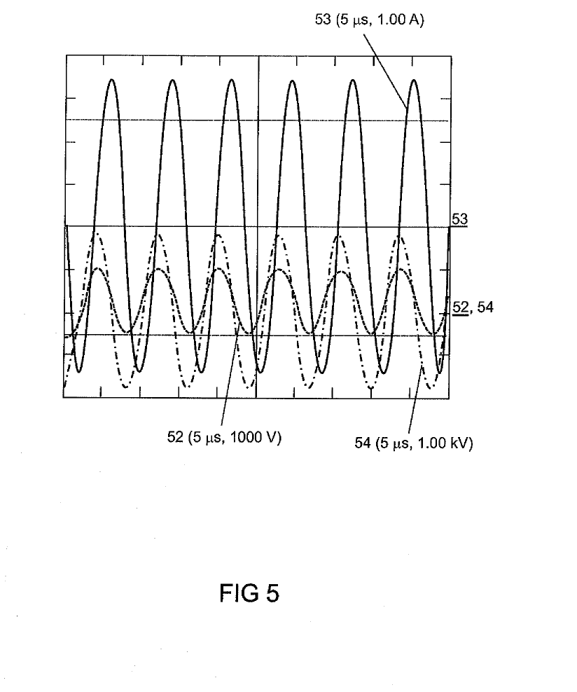

C2 virtually does not hinder the flow of current during the resonance excitation at the ignition voltage generation. FIG. 5 shows the current in the primary winding L2 (signal 43) and the voltage across the lamp during the ignition process. Here, a high-frequency alternating current flows alternately via D1 and D2 such that C2 is continuously reversed. The signal 53 illustrates this current. This high-frequency alternating current in the primary winding flows in this case via C2. The signal 52 represents the voltage across the resonance capacitor 19, and the signal 54 the ignition voltage across the lamp. The comparison with FIG. 3 indicates that the generation of the ignition voltage is not impaired by the DC blocking capacitor C2.

### Third Embodiment

The third embodiment is similar to the second embodiment. It is therefore only the differences in relation to the second embodiment that are described.

In the third embodiment, the second diode D2 is replaced by a controlled switch that, together with the DC voltage blocking capacitor (C2), enables a flow of current through the primary winding L2 of the ignition transformer 18 during the ignition. To this end, the switch is closed during the ignition operation, whereas it is open during the normal operation of the gas discharge lamp. Consequently, no appreciable current flows during the normal operation of the gas discharge lamp 5. When the switch is opened after the ignition, the diode D1 takes over the current still flowing through the primary winding L2 of the ignition transformer 18.

### Fourth Embodiment

The fourth embodiment is similar to the third embodiment. It is therefore only the differences in relation to the second embodiment that are described.

The fourth embodiment is further simplified by comparison with the third embodiment. The first diode D1 is economized in this embodiment such that when the switch is opened the interruption of the flow of current through the primary winding L2 of the ignition transformer 18 effects an elevated voltage across the primary winding L2 of the ignition transformer 18. In this case, the switch must be designed for this increased load, or else have an appropriate protective circuit for suppressing the elevated voltage.

1. A circuit arrangement for igniting and operating a gas discharge lamp having a half-bridge arrangement, which acts as a step-down inverter in quasi-resonant mode, a lamp inductor and a resonance capacitor that form a resonant circuit, and having an ignition transformer whose secondary winding is connected on the one hand to a lamp electrode and is connected on the other hand to the tie point between the lamp inductor and resonance capacitor, wherein the primary winding of the ignition transformer is connected with its first end to the tie point between the lamp inductor and resonance capacitor, and with its second end to the tie point of two series connected diodes, the first diode being connected to the power supply unit, and the second diode being connected to circuit ground.

2. The circuit arrangement as claimed in claim 1, wherein a DC blocking capacitor is connected in the path between the tie point, between the lamp inductor and resonance capacitor, and the circuit ground or the power supply unit.

3. The circuit arrangement as claimed in claim 2, wherein a DC blocking capacitor is connected between the primary winding of the ignition transformer and the tie point of the series connected diodes.

4. The circuit arrangement as claimed in claim 1, wherein the ratio of the inductances of the ignition transformer lies in the range between 0.5 and 10.

5. The circuit arrangement as claimed in claim 1, wherein the ratio of the inductances of the ignition transformer lies in the range between 0.7 and 5.

6. The circuit arrangement as claimed in claim 1, wherein a resonance voltage whose amplitude lies between 300 V and 1700 V is produced across the resonance capacitor during the ignition mode.

7. The circuit arrangement as claimed in claim 1, wherein the voltage ripple at the tie point between the lamp inductor and resonance capacitor is greater than 100 V from maximum to maximum during the operation with a low-frequency rectangular current.

8. The circuit arrangement as claimed in claim 1, wherein the second diode is designed as a controlled switch.

9. The circuit arrangement as claimed in claim 1, wherein the controlled switch is closed during the ignition process, and open during the operation with the low-frequency rectangular current.

10. The circuit arrangement as claimed in claim 7, wherein the first diode is omitted.

11. A method for igniting and operating a gas discharge lamp having a capacitor, a series circuit of an inductor, a transformer and the gas discharge lamp, the inductor acting as resonance inductor during ignition, the transformer acting as ignition transformer, and the capacitor acting as resonance capacitor, whereas during the operation of the gas discharge lamp the inductor acts as a lamp inductor, the transformer as filter inductor, and the capacitor as filter capacitor, the inductor and the capacitor forming a resonant circuit during the ignition, wherein the resonant circuit produces during the ignition a first voltage that results in a current through the primary winding of the ignition transformer, and thereupon a second voltage is produced across the secondary winding of the transformer, and the first and the second voltages are added together to form an ignition voltage in such a way that the ignition voltage across the lamp is enlarged by a factor of 1.5-10 by comparison with the first voltage, the current through the primary winding of the transformer being of such small dimension during the operation that the secondary winding of the ignition transformer acts as a filter inductor with the aid of a large part of its no-load inductance.

12. The method for igniting and operating a gas discharge lamp as claimed in claim 11, wherein the ignition voltage is enlarged by a factor of 1.5-3 by comparison with the first voltage.

13. The method for igniting and operating a gas discharge lamp as claimed in claim 11, wherein the resonant circuit is no longer appreciably excited during the lamp operation, and the current through the primary winding of the transformer thereby becomes negligibly small.

14. The method for igniting and operating a gas discharge lamp as claimed in claim 11, wherein located in series with the primary winding is at least one switching element that enables a flow of current through the primary winding of the transformer during ignition, and that suppresses the flow of current through the primary winding of the transformer during operation.
